(19) United States
(12) Patent Application Publication
(10) Pub. No.: US 2026/0284811 A1
(43) Pub. Date: Sep. 24, 2026

(54) SEPARATION TOOL AND METHOD FOR SHROUD SEGMENTS OF GAS TURBINES WITH INSULATION

(71) Applicant: GE Vernova Infrastructure Technology LLC, Greenville, SC (US)

(72) Inventors: Adam WOSZCZYK, Warsaw (PL); Jaroslaw MOLENDOWSKI, Warsaw (PL); Szymon PERKOWSKI, Warsaw (PL); Karol TUCKI, Warsaw (PL)

(21) Appl. No.: 19/566,533

(22) Filed: Mar. 13, 2026

(30) Foreign Application Priority Data
Mar. 20, 2025 (EP) 25461515.6

(51) Int. Cl. B23P 19/027; F01D 25/24

(52) U.S. Cl. CPC B23P 19/027; F01D 25/24; F05D 2230/70

(57) ABSTRACT

A tool and method for separating shroud segments in a turbine. The tool includes: a stabilizing member; a pair of arms, each arm having a first end and a second end, wherein the first end of each arm is pivotally connected to the stabilizing member; a pivot member extending from the second end of each arm; a linear actuator pivotally coupled between the pair of arms at a central portion of each respective arm; and a pair of transfer plates, each transfer plate being pivotally couplable to a respective pivot member.

### CROSS-REFERENCE TO RELATED APPLICATION

This application claims priority pursuant to 35 U.S.C. § 119(a) to European Patent Application No. 25461515.6, filed Mar. 20, 2025, which application is incorporated herein by reference in its entirety.

### TECHNICAL FIELD

The disclosure is related generally to turbine systems. More particularly, the disclosure is related to a turbine shroud segment separation apparatus.

### BACKGROUND

Conventional turbomachines, such as gas turbine systems, are utilized to generate power for electric generators. In general, gas turbine systems generate power by passing a fluid (e.g., hot gas) through a compressor and a turbine component of the gas turbine system. More specifically, inlet air may be drawn into a compressor and may be compressed. Once compressed, the inlet air is mixed with fuel to form a combustion product, which may be ignited by a combustor of the gas turbine system to form the operational fluid (e.g., hot gas) of the gas turbine system. The fluid may then flow through a fluid flow path for rotating a plurality of rotating buckets and shaft of the turbine component for generating the power. The fluid may be directed through the turbine component via the plurality of rotating buckets and a plurality of stationary nozzles positioned between the rotating buckets. As the plurality of rotating buckets rotate the shaft of the gas turbine system, a generator, coupled to the shaft, may generate power from the rotation of the shaft.

Conventional gas turbine systems typically include multiple shroud stages positioned within the turbine casing. More specifically, multiple shroud stages may be coupled to the turbine casing and may be positioned adjacent to the tips of the rotating buckets and/or between stator nozzles of the gas turbine system. The shroud stages may surround the various stages of rotating buckets and stator nozzles of the gas turbine system and may form the outer boundary of the operational fluid flowing through the gas turbine system during operation.

When a maintenance process is performed on a gas turbine system or an adjustment is made to various components of the gas turbine system, the turbine shroud stages may be removed. For example, when maintenance is performed or adjustments are made to the rotating buckets, stator nozzles and/or the shroud block themselves, the shroud stages may be removed to allow a turbine operator to access, maintain and/or adjust a specific component.

### SUMMARY

All aspects, examples and features mentioned below can be combined in any technically possible way.

An aspect of the disclosure provides a tool for separating shroud segments in a turbine, the tool comprising: a stabilizing member; a pair of arms, each arm having a first end and a second end, wherein the first end of each arm is pivotally connected to the stabilizing member; a pivot member extending from the second end of each arm; a linear actuator pivotally coupled between the pair of arms at a central portion of each respective arm; and a pair of transfer plates, each transfer plate being pivotally couplable to a respective pivot member.

Another aspect of the disclosure provides a method for separating shroud segments in a turbine. The method comprises providing a tool that includes: a stabilizing member; a pair of arms, each arm having a first end and a second end, wherein the first end of each arm is pivotally connected to the stabilizing member; a pivot member extending from the second end of each arm; and a linear actuator pivotally coupled between the pair of arms at a central portion of each respective arm; a pair of transfer plates, each transfer plate being pivotally couplable to a respective pivot member; installing the pair of transfer plates onto two adjacent shroud segments; coupling the pivot members to the pair of transfer plates; and expanding the linear actuator to radially separate the pair of transfer plates and separate the adjacent shroud segments.

Another aspect of the disclosure includes any of the preceding aspects, and wherein the pair of transfer plates are configured to releasably engage to adjacent shroud segments.

Another aspect of the disclosure includes any of the preceding aspects, and wherein the pair of transfer plates include retention pins to releasably engage to retention holes in the adjacent shroud segments.

Another aspect of the disclosure includes any of the preceding aspects, and wherein each pivot member includes a circular insert, and each transfer plate includes: a complementary circular opening that couples to the circular insert of a respective pivot member, and wherein the at least two retentions pins include a pair of retention pins.

Another aspect of the disclosure includes any of the preceding aspects, and wherein the circular insert and the pair of retention pins each have a center point, wherein the center point of the circular insert and the pair of retentions pins are substantially linearly aligned.

Another aspect of the disclosure includes any of the preceding aspects, and wherein each arm includes a first connection element pivotally connecting the first end of the arm to an end of the stabilizing member.

Another aspect of the disclosure includes any of the preceding aspects, and wherein each arm includes a second connection element for pivotally connecting the central portion of the arm to an end of the linear actuator.

Another aspect of the disclosure includes any of the preceding aspects, further comprising at least one shim configured to retain the pair of transfer plates relative to a rib of a turbine casing of the turbine.

Another aspect of the disclosure includes any of the preceding aspects, wherein each transfer plate includes an outer edge that extends beyond the second end of a respective arm.

Another aspect of the disclosure includes any of the preceding aspects, wherein the linear actuator includes a hydraulic cylinder including a connector for receiving a compressed fluid, wherein the compressed fluid causes the hydraulic cylinder to extend and radially move the pair of transfer plates apart to separate adjacent shroud segments.

Two or more aspects described in this disclosure, including those described in this summary section, may be combined to form implementations not specifically described herein. That is, all embodiments described herein can be combined with each other.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a turbine casing with a shroud segment separation tool according to an embodiment of the disclosure;

FIG. 2 shows a top perspective view of a shroud segment separation tool according to an embodiment of the disclosure;

FIG. 3 shows a bottom perspective view of a shroud segment separation tool according to an embodiment of the disclosure;

FIG. 4 shows a top perspective view of a shroud segment separation tool coupled to shroud segments according to an embodiment of the disclosure;

FIG. 5 shows transfer plates installed in a turbine casing according to an embodiment of the disclosure;

FIG. 6 shows a shroud segment separation tool installed in a turbine casing according to an embodiment of the disclosure;

FIG. 7 shows shims installed with the shroud segment separation tool in a turbine casing according to an embodiment of the disclosure; and,

FIG. 8 a shroud segment separation tool separating shroud segments.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION OF THE INVENTION

As an initial matter, in order to clearly describe the subject matter of the current technology, it will become necessary to select certain terminology when referring to and describing relevant machine components within the illustrative application of a turbine section. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbomachine or, for example, the flow of air through the combustor or coolant through one of the turbomachine's component systems. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the turbomachine, and “aft” referring to the rearward or turbine end of the turbomachine.

It is often required to describe parts that are at different radial positions with regard to a center axis. The term “axial” refers to movement or position parallel to an axis, e.g., an axis of a micromixer tube. The term “radial” refers to movement or position perpendicular to an axis, e.g., an axis of a micromixer tube. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential interior surface of micromixer tube. As indicated above, it will be appreciated that such terms may be applied in relation to the axis of the turbomachine.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs or the feature is present and instances where the event does not occur or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

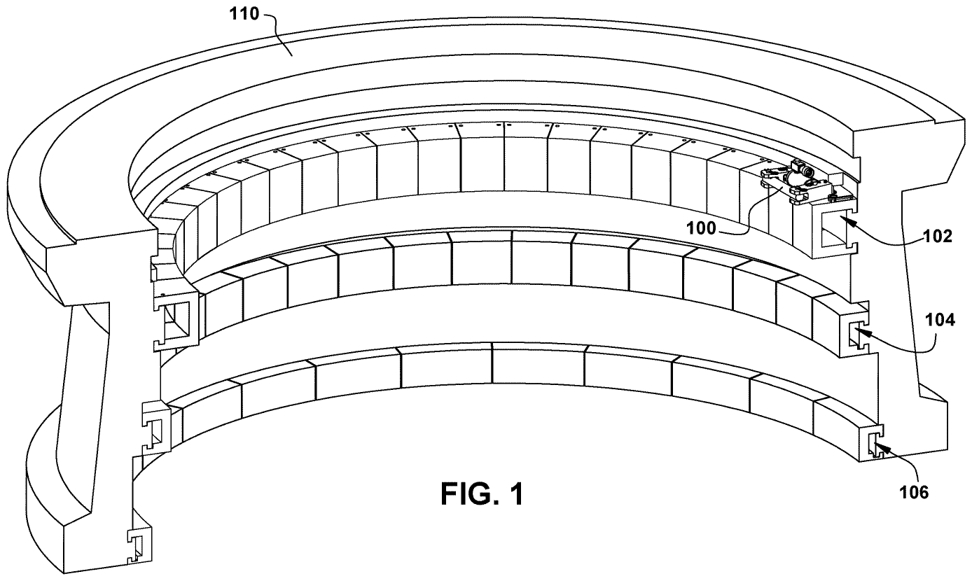

Embodiments of the disclosure provide a tool and associated method for separating shroud segments in a turbine casing. FIG. 1 depicts a turbine casing 110 having three shroud stages, including a first stage 102, second stage 104 and third stage 106. As shown, each stage includes a series of shroud segments installed along a curved inner surface of the casing 110. Removing shroud segments from the casing 110 can be a challenge, as segments in each stage can become stuck together and/or fused into the casing 110 over time due, e.g., to high operating temperatures. To separate individual shroud segments, a significant force must be applied, and care must be taken not to cause damage. Furthermore, because each shroud segment has a curved profile to mate with the curved inner surface of the casing 110, additional friction is imparted when trying to remove segments using a lateral separation force. To address this, a tool 100 is provided that is configured to separate adjacent shroud segments to facilitate their removal.

FIG. 2 depicts a detailed top perspective view of an illustrative tool 100, which generally includes: a pair of arms 200A, 200B, each having a first end pivotally connected to opposed ends of a stabilizing member 202 (e.g., a rigid bar or the like) and a second end connected to (or having) a pivot member 218A, 218B; a linear actuator 206 (e.g., a hydraulic cylinder) pivotally coupled between the pair of arms 200A, 200B at a central portion of each respective arm; and a pair of transfer plates 210A, 210B, wherein each transfer plate is rotationally couplable to a respective pivot member 218A, 218B. In the illustrative embodiment shown, the pair of arms 200A, 200B are pivotally connected to stabilizing member 202 using first connection elements 212A and 212B (e.g., shafts, cotter pins, bushings and/or other connection mechanisms). Similarly, the linear actuator 206 includes opposed cylinder ends pivotally connected to arms 200A, 200B with second connection elements 214A and 214B (e.g., shafts, cotter pins, bushings and/or other connection mechanisms). As shown, linear actuator 206, in this case a hydraulic cylinder, includes a connector 204 for connection to a pressurized fluid source (not shown). As is understood in the art, a hydraulic cylinder is a mechanical device that uses pressurized hydraulic fluid to generate linear motion, essentially pushing or pulling a load by moving a piston within a cylinder barrel, creating force in a straight line. In other embodiments, an alternative device that performs a similar function, e.g., a threaded rod, a pneumatic cylinder, a turnbuckle, etc., could be utilized instead of a hydraulic cylinder.

As described in further detail herein, the transfers plates 210A, 210B are configured to releasably engage to adjacent shroud segments (not shown) within the turbine casing 110 (FIG. 1). When the linear actuator 206 expands, the pair of arms 200A, 200B swing apart about first connection elements 212A, 212B and cause transfer plates 210A, 210B to push apart. Each pivot member 218A, 218B includes a circular insert 216 that couples with a complementary circular opening 217 in a respective transfer plate 210A, 210B, which allows each transfer plate 210A, 210B to rotate about the circular insert 216, e.g., in a hinge-like manner. Accordingly, as the linear actuator 206 linearly expands, transfer plates 210A, 210B rotationally spread apart to substantially follow the curved profile of the shroud segments/inner surface of the casing 110.

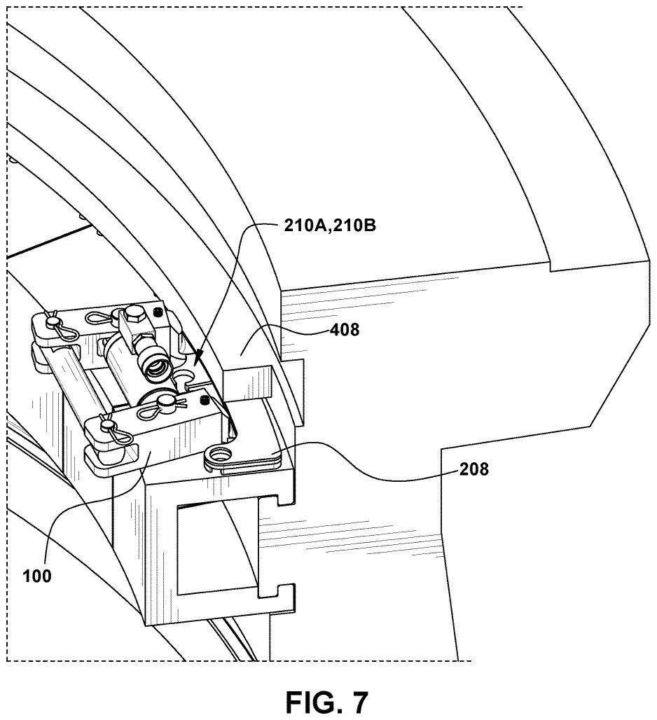

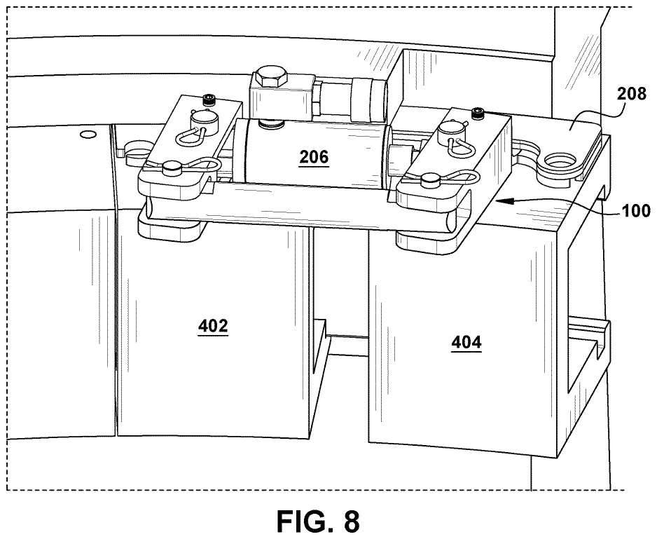

Also depicted are a set of shims 208 which can be placed as needed on top of transfer plates 210A, 210B to maintain the tool 100 within the casing 110 during a shroud separation procedure. This procedure is described in further detail with respect to FIGS. 7 and 8.

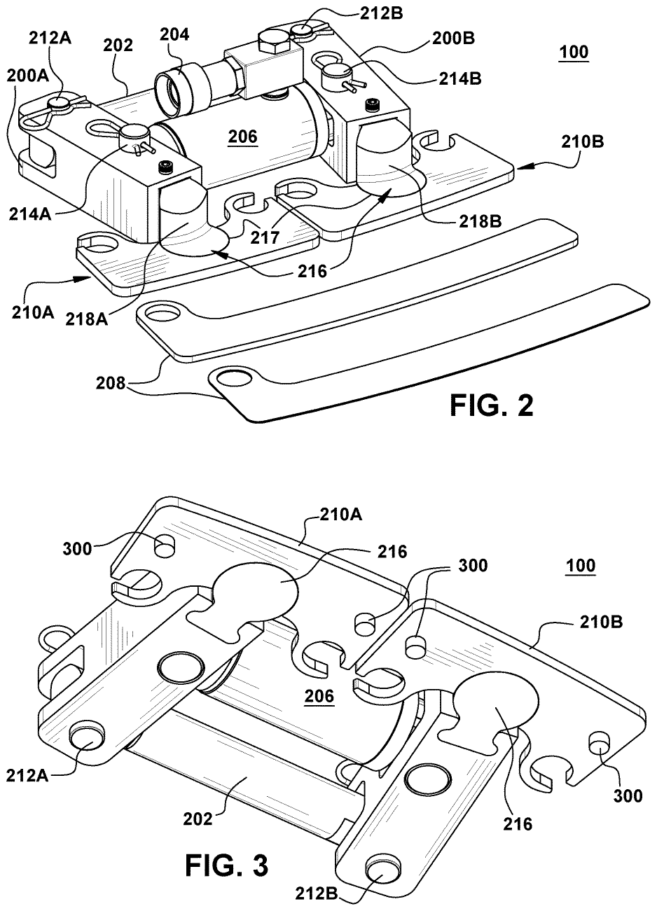

FIG. 3 depicts a detailed bottom perspective view of the tool 100. As can be seen, the underside of transfer plates 210A, 210B includes pins 300 that are configured to mate (i.e., releasably connect) with existing holes (i.e., retention holes) in adjacent shroud segments. In certain embodiments, each transfer plate includes a pair of retention pins to engage a pair of retention holes. However, it is understood that the number of pins and holes may vary depending upon the shroud configuration. In some aspects, on each transfer plate 210A, 210B, the circular insert 216 and retention pins 300 each having center points that substantially align, which reduces torque on the retention pins 300 as the shroud segments separate. Furthermore, it is understood that transfer plates 210A, 210B may be configured for a specific shroud stage in a specific turbine. Accordingly, different transfer plate sizes and configurations may be provided for different shroud sizes and configurations. As such, transfer plates 210A, 210B are releasably coupled to the pivot members 218A, 218B, e.g., by slidable engagement, snapping in, etc.

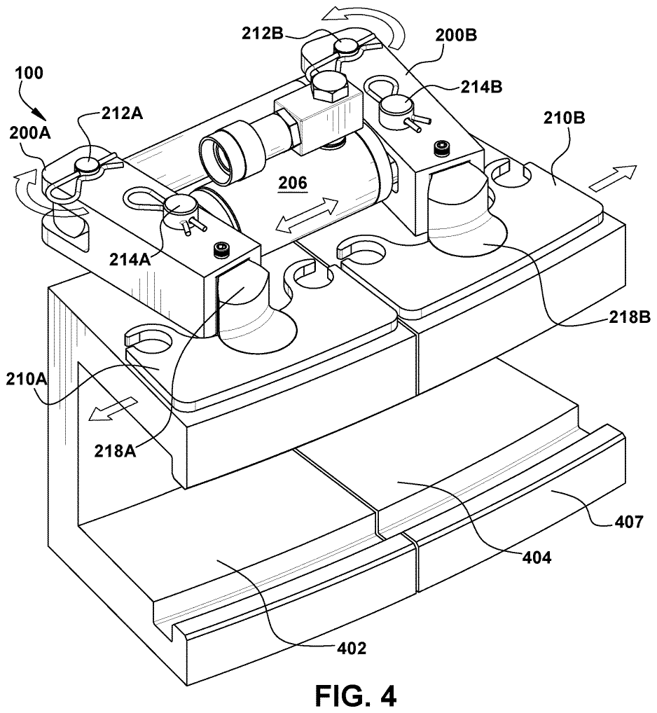

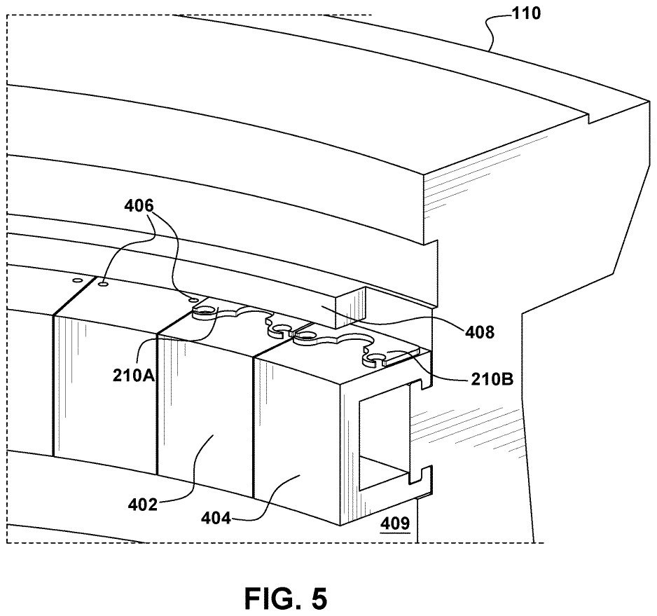

FIG. 4 shows tool 100 coupled to adjacent shroud segments 402, 404. In operation, as the linear actuator 206 expands, the ends thereof push against second connection elements 214A, 214B that are pivotally connected to a central portion of each arm 200A, 200B, which causes arms 200A, 200B to rotate outward about first connection elements 212A, 212B. As transfer plates 210A, 210B are forced apart, pivot members 218A, 218B allow the transfer plates to rotate while separating adjacent shroud segments 402, 404. The separating force accordingly is radial in nature to substantially match the curved profile 407 of the shrouds. The radial separating force more effectively separates adjacent shroud segments 402, 404, allowing the segments to also separate from a seal plate 409 (see FIG. 5) that resides below the shroud segments without undue damaging forces.

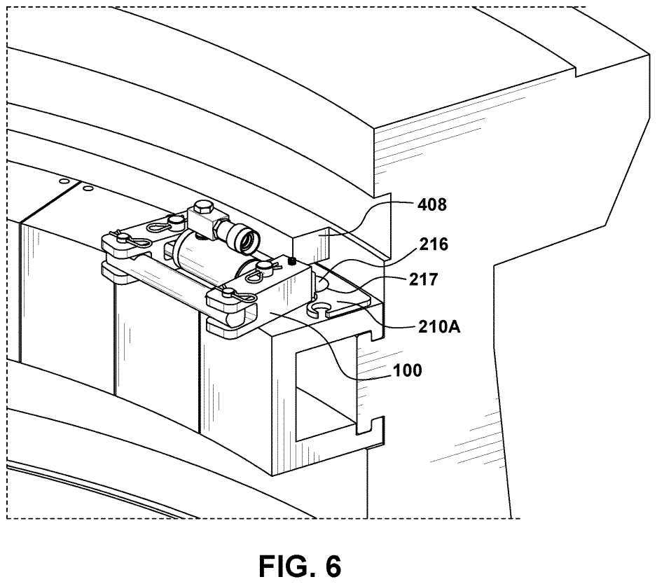

FIGS. 5-8 depict images showing a method of using the tool 100 to separate shroud segments within casing 110. Initially, as shown in FIG. 5, transfer plates 210A, 210B are inserted and coupled onto adjacent shroud segments 402, 404. Retention pins 300 (not shown) on the underside of the transfer plates 210A, 210B are placed into existing retention holes 406 on the top of the adjacent shrouds 402, 404, beneath casing rib 408. Next, as shown in FIG. 6, the circular inserts 216 of the pivot elements 218A, 218B are slid, placed or snapped into the complementary circular openings 217 of transfer plates 210A, 210B (partially blocked in this view-see, e.g., FIG. 2). As can be seen, a slight gap may exist between a top surface of the transfer plate 210A and the bottom of casing rib 408, which could cause the tool 100 to uncouple from the shroud segments. To address this, one or more shims 208 may be placed above the transfer plates 210A, 210B and below the casing rib 408 to eliminate the gap, as shown in FIG. 7. This ensures that the tool 100 will remain snuggly in place during a separation operation, thus allowing a single operator to implement the operation. As shown in FIG. 8, as the tool 100 is expanded, shroud segments 402, 404 readily separate.

Tool 100 and the associated method of using the tool 100 have numerous technical and commercial advantages. Notably, the scissor design of tool 100 provides a radial force that substantially matches the curved profile of the shroud segments/inner surface of casing 110, thus providing a more effective force for separating shroud segments. Furthermore, because of the location of casing rib 408, there is little room to access the existing holes 406 on the shroud segments. The present design addresses this by having transfer plates 210A, 210B that extend out beyond the ends of arms 200A, 200B, which allows the transfer plates 210A, 210B to slide into the gap formed by the casing rib 408, i.e., the tool 100 can be installed in very confined spaces. Still further, different transfer plate configurations can be utilized for different shroud designs. Moreover, because of the placement of the linear actuator 206 between central portions of the arms 200A, 200B, a large stroke is achieved sufficient for complete shroud separation for different types of gas turbines.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described to best explain the principles of the disclosure and the practical application of the technology and to enable others of ordinary skill in the art to understand the disclosure for contemplating various modifications to the present embodiments, which may be suited to the particular use contemplated.

What is claimed is:

1. A tool for separating shroud segments in a turbine, the tool comprising:
a stabilizing member;
a pair of arms, each arm having a first end and a second end, wherein the first end of each arm is pivotally connected to the stabilizing member;
a pivot member extending from the second end of each arm;
a linear actuator pivotally coupled between the pair of arms at a central portion of each respective arm; and,
a pair of transfer plates, each transfer plate being pivotally couplable to a respective pivot member.

2. The tool of claim 1, wherein the pair of transfer plated are configured to releasably engage adjacent shroud segments.

3. The tool of claim 2, wherein each transfer plate includes at least two retention pins to releasably engage to at least two retention holes in a respective one of the adjacent shroud segments.

4. The tool of claim 3, wherein each pivot member includes a circular insert and each transfer plate comprises:
a complementary circular opening that couples to the circular insert of a respective pivot member, and wherein the at least two retentions pins include a pair of retention pins.

5. The tool of claim 4, wherein the circular insert and the pair of retention pins each have a center point, wherein the center point of the circular insert and the pair of retentions pins are substantially linearly aligned.

6. The tool of claim 1, wherein each arm comprises a first connection element pivotally connecting the first end of the arm to an end of the stabilizing member.

7. The tool of claim 1, wherein each arm includes a second connection element for pivotally connecting the central portion of the arm to an end of the linear actuator.

8. The tool of claim 1, further comprising at least one shim configured to retain the pair of transfer plates relative to a rib of a turbine casing of the turbine.

9. The tool of claim 1, wherein each transfer plate comprises an outer edge that extends beyond the second end of a respective arm.

10. The tool of claim 1, wherein the linear actuator comprises a hydraulic cylinder including a connector for receiving a compressed fluid, wherein the compressed fluid causes the hydraulic cylinder to extend and radially move the pair of transfer plates apart to separate adjacent shroud segments.

11. A method for separating shroud segments in a turbine, the method comprising:
providing a tool that comprises:
a stabilizing member;
a pair of arms, each arm having a first end and a second end, wherein the first end of each arm is pivotally connected to the stabilizing member;
a pivot member extending from the second end of each arm;
a linear actuator pivotally coupled between the pair of arms at a central portion of each respective arm;
a pair of transfer plates, each transfer plate being pivotally couplable to a respective pivot member;
installing the pair of transfer plates onto two adjacent shroud segments;
coupling the pivot members to the pair of transfer plates; and,
expanding the linear actuator to radially separate the pair of transfer plates and separate the adjacent shroud segments.

12. The method of claim 11, wherein an outer edge of the pair of transfer plates is installed between a surface of the two adjacent shroud segments and a rib of a turbine casing.

13. The method of claim 12, further comprising inserting at least one shim between the pair of transfer plates and the rib.

14. The method of claim 11, wherein the pair of transfer plates comprises at least two retention pins to releasably engage to respective retention holes in the adjacent shroud segments.

15. The method of claim 14, wherein
each pivot member comprises a circular insert;
each transfer plate includes a complementary circular opening that couples to the circular insert of a respective pivot member;
the at least two retentions pins comprise
a pair of retention pins; and,
the circular insert and pair of pins each have center points that substantially align.

16. The method of claim 11, wherein each arm comprises a first shaft for pivotal connection to an opposed end of the stabilizing member.

17. The method of claim 11, wherein each arm comprises a second connection element for pivotal connection to a respective end of the linear actuator.

18. The method of claim 11, wherein each transfer plate comprises an outer edge that extends beyond the second end of a respective arm.

19. The method of claim 11, wherein the pair of transfer plates are each removably coupled to a respective pivot member.

20. The method of claim 19, wherein the pair of transfer plates are selectively installed based on a configuration of the adjacent shroud segments.
